(19) United States
(12) Patent Application Publication
(10) Pub. No.: US 2022/0268646 A1
(43) Pub. Date: Aug. 25, 2022

(54) PRESSURE SENSING SYSTEM AND PRESSURE SENSING SETTING METHOD

(71) Applicant: PI BIOELECTRONICS CO., LTD, Taichung City (TW)

(72) Inventors: Min-Hui ChiouChang, Taichung City (TW); Sheng-Chuan Liang, Taichung City (TW); Yung-Jiun Lin, Taichung City (TW); Wei-Ting Hsieh, Taichung City (TW)

(21) Appl. No.: 17/621,187

(22) PCT Filed: Jun. 26, 2019
(86) PCT No.: PCT/CN2019/092885

§ 371 Date: Dec. 20, 2021

(51) Int. Cl. G01L 1/00

(52) U.S. Cl. CPC G01L 1/005

(57) ABSTRACT

A pressure sensing system and a pressure sensing setting method are provided. The pressure sensing system includes a first pressure sensing sheet, a second pressure sensing sheet, and a processing device. The first flexible substrate of the first pressure sensing sheet has a first conductive pattern; the second flexible substrate of the second pressure sensing sheet has a second conductive pattern. The second pressure sensing sheet has the second conductive pattern stacked with the first conductive pattern of the first pressure sensing sheet. The processing device outputs electric signal to the first pressure sensing sheet; the second pressure sensing sheet obtains a pressure sensing signal, which is compared with a threshold value, determining if the first pressure sensing sheet and the second pressure sensing sheet are pressed by an external force, thereby preventing erroneous signal and improving measurement accuracy.

### BACKGROUND OF THE INVENTION

### 1. Field of the Invention

The present invention relates to pressure sensing fields, and more particularly, to a flexible electronic pressure sensing system and pressure sensing setting method.

### 2. Description of the Related Art

A flexible electronic pressure device is disposed on a flexible or bendable substrate and provided with a pressure sensing structure, so as to carry out a pressure measurement through the pressure sensing structure, wherein the flexible electronic pressure device is suitable for measuring environment with large areas and bending properties, such as ultra-thin sensitivity adjustable keyboards applied for tablet computers, active pressure pen components, wearable pressure sensing components, or pressure sensing components for medical testing, etc.

However, when the flexible electronic pressure device is bent, the electrical signals output easily becomes unstable to cause measurement errors. In order to improve the aforementioned problems, U.S. Pat. No. 7,980,144B2 discloses a flexible electronic pressure sensing device and manufacturing method thereof, including multiple layers of soft films, a plurality of electrodes, a plurality of sensing blocks, and a plurality of bumps, wherein two spaces are defined between each soft film, each electrode and sensing block are disposed on the soft film and arranged in one of the spaces, each bump is disposed on the soft film and arranged in the other space, and the air in the two spaces maintain the relative distance between the two soft films of each electrode and sensing block. When the flexible electronic pressure sensing device is deformed, the sensing block and the electrode or the two sensing blocks respectively disposed on different soft films are prevented from contacting each other and accordingly resulting in an erroneous sensing signal.

However, the aforementioned patent requires a complicated structure design, a large amount of manufacturing processes and cost to prevent the contacting each other of soft films and accordingly generating erroneous signals without bearing pressures.

Also, when the flexible electronic pressure sensing device of the aforementioned patent is applied to the wearable component for medical testing, the sensing blocks and bumps convex on the soft films easily cause a sensation of foreign body, so that the user has an uncomfortable sensation.

### SUMMARY OF THE INVENTION

In order to solve the above-mentioned issues, the present invention provides a pressure sensing system and pressure sensing setting method thereof. Through the setting and identification of the threshold value, two electrodes are prevented from contacting each other without additional complicated structures, thereby effectively simplifying the manufacturing process and improving the reliability, increasing application range and measurement comfort thereof.

An embodiment of the present invention provides a pressure sensing system, comprising:

a first pressure sensing sheet comprising a first flexible substrate and a first conductive pattern, the first conductive pattern being disposed on a surface of the first flexible substrate;

a second pressure sensing sheet comprising a second flexible substrate and a second conductive pattern, the second conductive pattern being disposed on a surface of the second flexible substrate, wherein the second pressure sensing sheet has one side of the second conductive pattern stacked with one side of the first conductive pattern of the first pressure sensing sheet; and

a processing device electrically connected with the first pressure sensing sheet and the second pressure sensing sheet, the processing device outputting an electric signal to the first pressure sensing sheet, the second pressure sensing sheet obtaining a pressure sensing signal; the pressure sensing signal being compared with a threshold value, so as to determine if the first pressure sensing sheet and the second pressure sensing sheet are pressed by an external force.

In one of the embodiments, the first conductive pattern comprises a first high conductivity circuit and a first low conductivity circuit electrically connected with the first high conductivity circuit. The first low conductivity circuit extends from the first high conductivity circuit to form a first pressure sensing area on the first flexible substrate; the first pressure sensing area has a square measure larger than the square measure on the first flexible substrate occupied by the first high conductivity circuit. The second conductive pattern comprises a second high conductivity circuit and a second low conductivity circuit electrically connected with the second high conductivity circuit. The second low conductivity circuit extends from the second high conductivity circuit to form a second pressure sensing area on the second flexible substrate; the second pressure sensing area has a square measure larger than the square measure on the second flexible substrate occupied by the second high conductivity circuit.

In one of the embodiments, the first low conductivity circuit is divided into a first cover area and a first distribution area. The first cover area is disposed on one side of the first high conductivity circuit away from the first flexible substrate, and the first distribution area is disposed on the first flexible substrate. The second low conductivity circuit is divided into a first cover area and a second distribution area. The second cover area is disposed on one side of the second high conductivity circuit away from the second flexible substrate, and the second distribution area is disposed on the second flexible substrate.

In one of the embodiments, the first pressure sensing sheet further comprises a first insulation layer; the first insulation layer covers one side of the first high conductivity circuit away from the first flexible substrate. The second pressure sensing sheet further comprises a second insulation layer; the second insulation layer covers one side of the second high conductivity circuit away from the second flexible substrate.

In one of the embodiments, the first insulation layer covers the first cover area; the second insulation layer covers the second cover area.

In one of the embodiments, a plurality of first conductive patterns are provided; each first conductive pattern comprises a first transmission portion; each first transmission portion is independently electrically connected with the processing device; two ends of each first transmission portion are connected with the processing device and a first conductive pattern, respectively. A plurality of second conductive patterns are provided; each second conductive pattern comprises a second transmission portion; each second transmission portion is electrically connected with the processing device, respectively; two end of each second transmission portion are connected with the processing device and a second conductive pattern, respectively.

In one of the embodiments, a plurality of first conductive patterns are provided; each first conductive pattern comprises a first transmission portion; each first conductive pattern is arranged in a two-dimensional array; the first transmission portions of each first conductive pattern are connected along a first direction. A plurality of second conductive patterns are provided; each second conductive pattern comprises a second transmission portion; each second conductive pattern is arranged in a two-dimensional array; the second transmission portions of each second conductive pattern are connected along a second direction. The first direction crosses the second direction.

In one of the embodiments, the pressure sensing signal is a current value. When the pressure sensing signal is larger than the threshold value, the processing device determines that the first pressure sensing sheet and the second pressure sensing sheet are pressed by an external force.

With the aforementioned configuration, in the present invention, the first pressure sensing sheet and the second pressure sensing sheet are stacked to obtain the pressure sensing signal, and the pressure sensing signal is compared with the threshold value to generate an effective measurement result. Therefore, through the combination of a simple structure and the setting of threshold value, the erroneous measure signal is effectively prevented from being generated, and the conventional complicated structure is improved, thereby avoiding erroneous measurements.

Also, the present invention transmits the electric signal through the first high conductivity circuit to the first low conductivity circuit. When the first low conductively circuit and the second low conductivity circuit contact, the pressure sensing signal is generated, and the pressure sensing signal is sent back through the second high conductivity circuit to the processing device. Thus, the sensitivity and accuracy of measure is improved through the high and low conductivity circuits.

Further, through the first insulation layer and the second insulation layer, the present invention prevents the issue of excessive current consumption due to the contact of the first high conductivity circuit and the second high conductivity circuit.

Also, the amount of conductive patterns can be increased according to requirement of measurement square measure. In addition, when each conductive pattern is pressed, the pressure sensing signal is sent back through the transmission portion to the processing device, respectively, so as to determine the pressed portion and square measure for identifying the pressure variation of different ranges.

An embodiment of the present invention provides a pressure sensing setting method, which is executed using the pressure sensing system. The pressure sensing setting method comprises following steps: the processing device receiving an initial signal which is generated by the second pressure sensing sheet when the first pressure sensing sheet and the second pressure sensing sheet are not pressed by an external force; the processing device receiving a pressurized signal generated by the second pressure sensing sheet when the first pressure sensing sheet and the second pressure sensing sheet are pressed by an external force; and the processing device processing the initial signal and the pressurized signal to generate the threshold value.

In one of the embodiments, the processing device divides the sum of the initial signal and pressurized signal by a reference value to obtain the threshold value.

With such configuration, the present invention processes the initial signal generated without external force pressurization and the pressurized signal generated with external force pressurization to generate the threshold value which is taken as the preferred determination basis. Therefore, the threshold values can be customized according to different usages for improving accuracy of measurement.

### BRIEF DESCRIPTION OF THE DRAWINGS

FIG. 1 is a schematic view of the first embodiment of the present invention.

FIG. 2 is a sectional schematic view of the first model of the pressure sensing sheet in accordance with the first embodiment of the present invention, illustrating the first high conductivity circuit being directly connected with the first insulation layer.

FIG. 3 is a schematic view of the first embodiment of the present invention illustrating the first model of the first pressure sensing sheet and the second pressure sensing sheet not being pressed.

FIG. 4 is a schematic view of the first embodiment of the present invention illustrating the first model of the first pressure sensing sheet and the second pressure sensing sheet being pressed.

FIG. 5 is a sectional schematic view of the second model of the first pressure sensing sheet in accordance with the first embodiment of the present invention, illustrating a first low conductivity circuit disposed between the first high conductivity circuit and the first insulation layer.

FIG. 6 is a schematic view of the first embodiment of the present invention illustrating the second model of the first pressure sensing sheet and the second pressure sensing sheet not being pressed.

FIG. 7 is a schematic view of the first embodiment of the present invention illustrating the second model of the first pressure sensing sheet and the second pressure sensing sheet being pressed.

FIG. 8 is a schematic view of the second embodiment of the present invention.

FIG. 9 is a schematic view of the third embodiment of the present invention.

FIG. 10 is a schematic view of the third embodiment of the present invention illustrating the first pressure sensing sheet and the second pressure sensing sheet contacting each other.

FIG. 11 is a schematic view of the third embodiment of the present invention illustrating the first pressure sensing sheet and the second pressure sensing sheet being stacked and pressurized.

### DETAILED DESCRIPTION OF THE INVENTION

For facilitating the description of the invention idea of the present invention shown in the above-mentioned summary of the invention column, specific examples are used for illustration. Various objects in the embodiments are drawn according to the proportion, size, deformation or displacement appropriate for explanation, instead of being drawn according to the proportion of actual elements and relative position thereof.

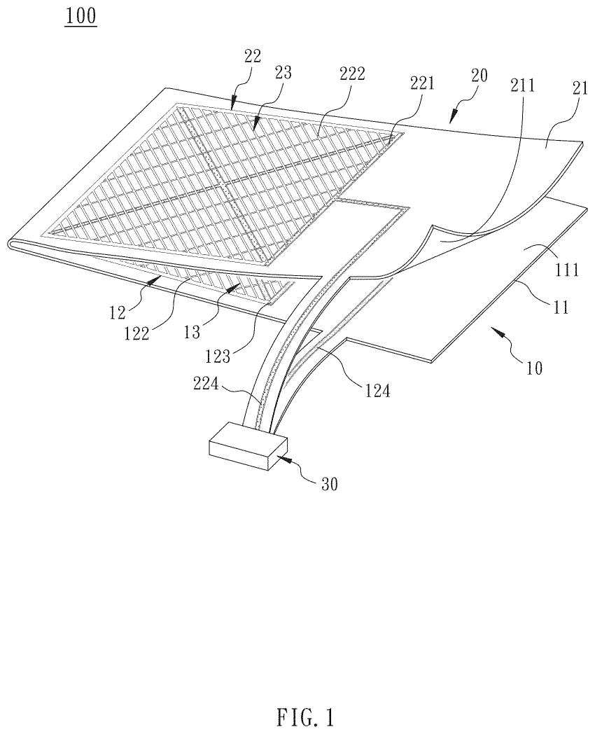

Referring to FIG. 1 to FIG. 7, the first embodiment of the present invention provides a pressure sensing system 100, comprises a first pressure sensing sheet 10, a second pressure sensing sheet 20, and a processing device 30.

The first pressure sensing sheet 10 comprises a first flexible substrate 11 and a first conductive pattern 12. The first conductive pattern 12 is disposed on the surface 111 of the first flexible substrate 11. In the embodiment, the first conductive pattern 12 is formed on the surface 111 of the first flexible substrate 11 in a printed circuit manner. Thus, the first pressure sensing sheet 10 is formed in a thin sheet having a flat surface.

The first conductive pattern 12 comprises a first high conductivity circuit 121, a first low conductivity circuit 122, a first insulation layer 123, and a first transmission portion 124. The first high conductivity circuit 121 and the first low conductivity circuit 122 are electrically connected with the first transmission portion 124. The first insulation layer 123 covers one side of the first high conductivity circuit 121 away from the first flexible substrate 11. Therein, the first low conductivity circuit 122 extends from the first high conductivity circuit 121 to form a first pressure sensing area 13 on the first flexible substrate 11. The first pressure sensing area 13 has a square measure larger than the square measure occupied by the first high conductivity circuit 121 on the first flexible substrate 11. In the embodiment, the first high conductivity circuit 121 is formed of silver material, and the first low conductivity circuit 122 is formed of a conductive carbon material. The first conductive pattern 12 is approximately formed in a rectangular shape. The first high conductivity circuit 121 is disposed on at least one side of the rectangularly shaped periphery, and arranged within the rectangular shape in a branch crossing manner. The first low conductivity circuit 122 is extended from the first high conductivity circuit 121 into a crossing mesh structure.

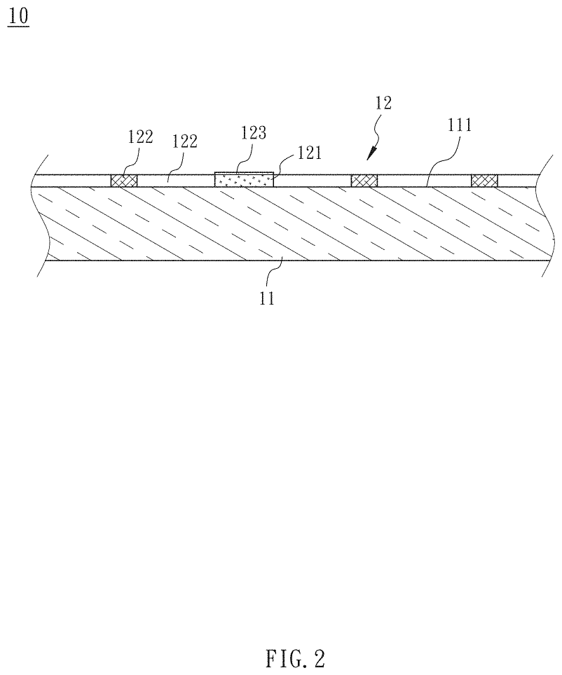

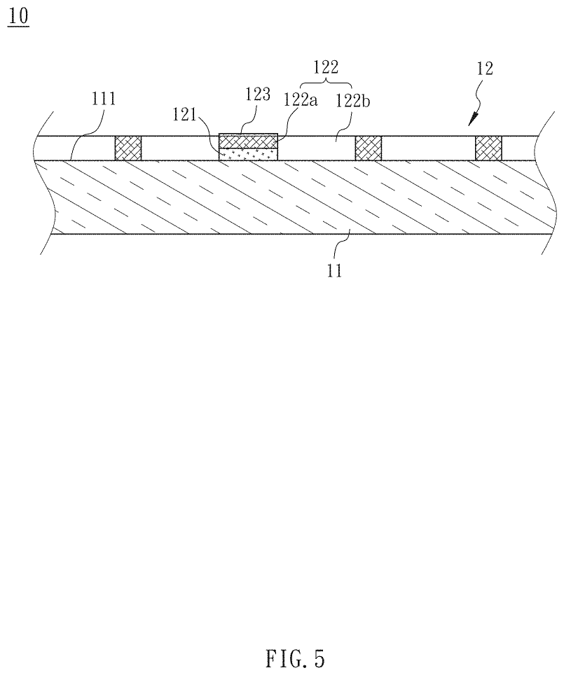

Further, the first insulation layer 123 directly covers the first high conductivity circuit 121 or indirectly covers the first high conductivity circuit 121. Referring to FIG. 2 to FIG. 4, the first model of the first conductive pattern 12 is disclosed, wherein the first insulation layer 123 directly covers the first high conductivity circuit 121. Referring to FIG. 5 to FIG. 7, the second model of the first conductive pattern 12 is disclosed, wherein the first insulation layer 123 indirectly covers the first high conductivity circuit 121. Therein, the first low conductivity circuit 122 is divided into a first cover area 122a and a first distribution area 122b. The first cover area 122a is disposed on one side of the first high conductivity circuit 121 away from the first flexible substrate 11. The first insulation layer 123 covers the first cover area 122a, and the first distribution area 122b is disposed on the surface 111 of the first flexible substrate 11.

The second pressure sensing sheet 20 comprises a second flexible substrate 21 and a second conductive pattern 22. The second conductive pattern 22 is disposed on the surface 211 of the second flexible substrate 21. In the embodiment, the second conductive pattern 22 is formed on the surface 211 of the second flexible substrate 21 in a printed circuit manner. Thus, the second pressure sensing sheet 20 is formed in a thin sheet having a flat surface.

The second conductive pattern 22 comprises a second high conductivity circuit 221, a second low conductivity circuit 222, a second insulation layer 223, and a second transmission portion 224. The second high conductivity circuit 221 and the second low conductivity circuit 222 are electrically connected with the second transmission portion 224. The second insulation layer 223 covers one side of the second high conductivity circuit 221 away from the second flexible substrate 21. Therein, the second low conductivity circuit 222 extends from the second high conductivity circuit 221 to form a second pressure sensing area 23 on the second flexible substrate 21. The second pressure sensing area 23 has a square measure larger than the square measure occupied by the second high conductivity circuit 221 on the second flexible substrate 21. In the embodiment, the second high conductivity circuit 221 is formed of silver material, and the second low conductivity circuit 222 is formed of a conductive carbon material. The second conductive pattern 22 is approximately formed in a rectangular shape. The second high conductivity circuit 221 is disposed on at least one side of the rectangularly shaped periphery, and arranged within the rectangular shape in a branch crossing manner. The second low conductivity circuit 222 is extended from the second high conductivity circuit 221 into a crossing mesh structure.

Further, the second insulation layer 223 directly covers the second high conductivity circuit 221 or indirectly covers the second high conductivity circuit 221. When the second insulation layer 223 indirectly covers the second high conductivity circuit 221, the second low conductivity circuit 222 is divided into a second cover area 222a and a second distribution area 222b. The second cover area 222a is disposed on one side of the second high conductivity circuit 221 away from the second flexible substrate 21. The second insulation layer 223 covers the second cover area 222a, and the second distribution area 222b is disposed on the surface 211 of the second flexible substrate 21.

Also, in the embodiment, the first pressure sensing sheet 10 and the second pressure sensing sheet 20 have an identical structure. In other words, the first conductive pattern 12 and the second conductive pattern 22 are disposed in an identical manner. However, according to different usage conditions, different structures are allowed to be applied. Besides, the first flexible substrate 11 and the second flexible substrate 21 are formed of transparent plastic material in the embodiment, but different flexible materials can be applied according to different usage demands.

The processing device 30 is electrically connected with the first pressure sensing sheet 10 and the second pressure sensing sheet 20, wherein the surface 211 of the second conductive pattern 22 of the second pressure sensing sheet 20 is stacked with the surface 111 of the first conductive pattern 12 of the first pressure sensing sheet 10. When the processing device 30 outputs an electric signal, the electric signal is inputted from the first transmission portion 124 of the first pressure sensing sheet 10 to the first high conductivity circuit 121, such that the first high conductivity circuit 121 transmits the electric signal to the first pressure sensing area 13 of the first low conductivity circuit 122. Then, when the second pressure sensing area 23 of the second pressure sensing sheet 20 contacts the first pressure sensing area 13 of the first pressure sensing sheet 10, the first pressure sensing area 13 of the first low conductivity circuit 122 and the second pressure sensing area 23 of the second low conductivity circuit 222 generate a pressure sensing signal, and the pressure sensing signal is transmitted by the second high conductivity circuit 221 through the second transmission portion 224 back to the processing device 30. The processing device 30 compares the pressure sensing signal with a threshold value, so as to determine if the first pressure sensing sheet 10 and the second pressure sensing sheet 20 are pressed by an external force and the strength of the external force.

Also, in the embodiments, the pressure sensing signal is a current value. When the pressure sensing signal is larger than the threshold value, the processing device 30 determines that the first pressure sensing sheet 10 and the second pressure sensing sheet 20 are pressed by an external force.

To further illustrate, the present invention provides a pressure sensing setting method executed by the pressure sensing system 100. The pressure sensing setting method comprises a first signal receiving step, a second signal receiving step, and a signal processing step.

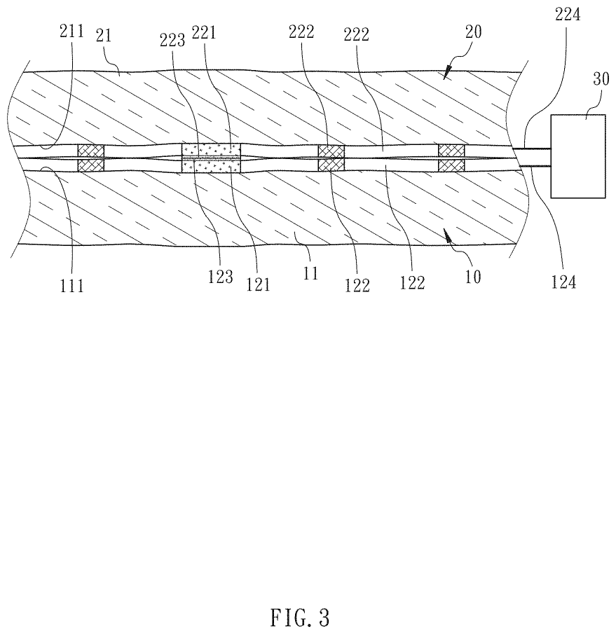

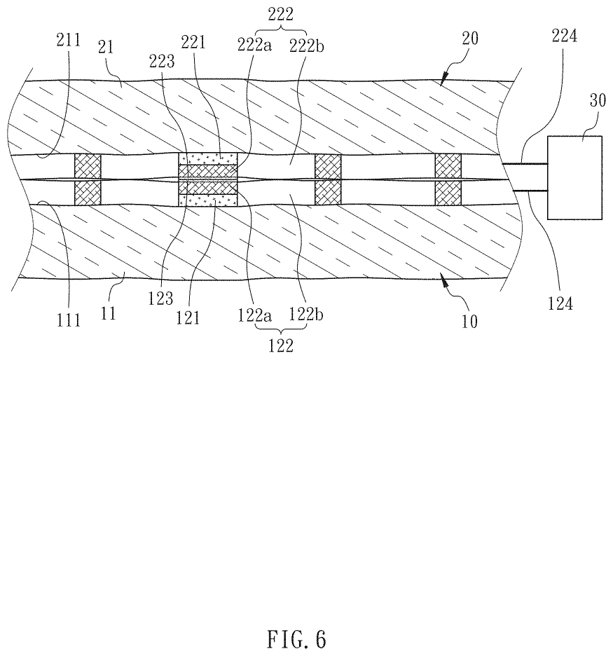

In the first signal receiving step, the first pressure sensing sheet 10 and the second pressure sensing sheet 20 are stacked up. When the first pressure sensing sheet 10 and the second pressure sensing sheet 20 are not pressed by an external force, the first pressure sensing area 13 of the first pressure sensing sheet 10 contacts the second pressure sensing area 23 of the second pressure sensing sheet 20, and the second pressure sensing sheet 20 generates an initial signal, which is received by the processing device 30, as shown by FIG. 3 and FIG. 6.

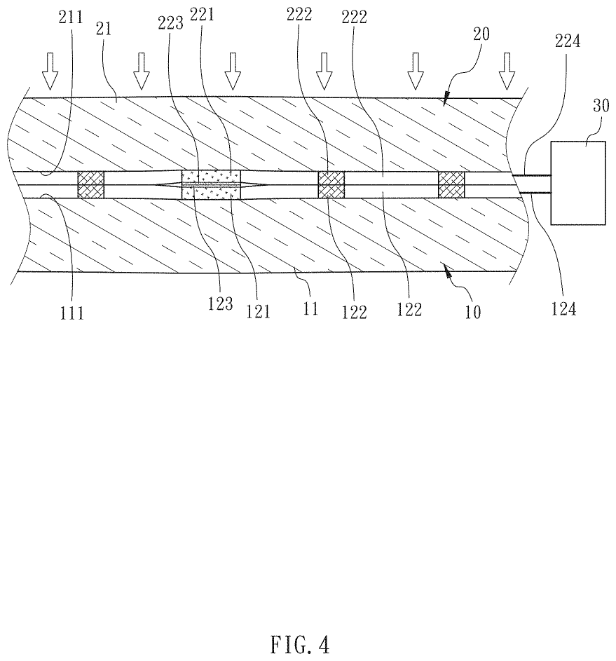

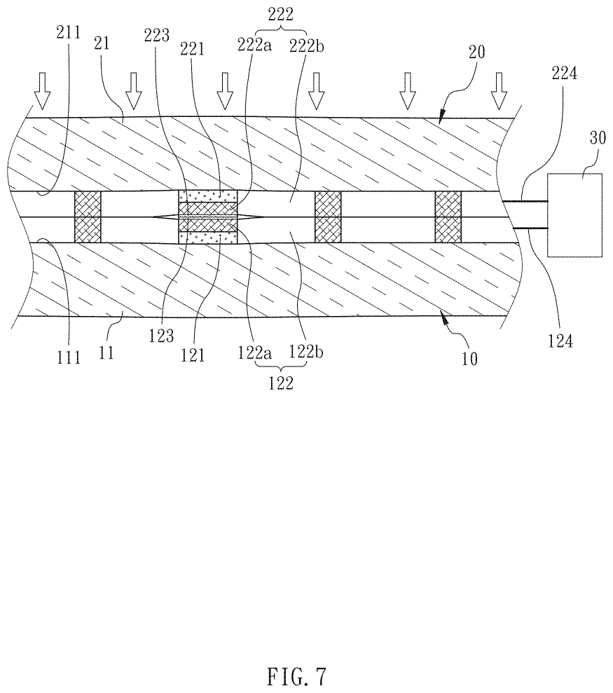

In the second signal receiving step, when the first pressure sensing area 13 of the first pressure sensing sheet 10 and the second pressure sensing area 23 of the second pressure sensing sheet 20 are pressed by an external force, and the second pressure sensing sheet 20 generates a pressurized signal, as shown by FIG. 4 and FIG. 7.

In the signal processing step, the processing device 30 processes the initial signal and the pressurized signal to generate a threshold value, wherein the processing device 30 divides the sum of the initial signal and the pressurized signal by a reference value to obtain the threshold value. In the embodiment, the reference value is 4, and the threshold value is between the initial signal and the pressurized signal and biased toward the initial signal end.

Therefore, when the pressure sensing system 100 of the present invention is used in different applications, the initial signal generated when the first pressure sensing sheet 10 and the second pressure sensing sheet 20 are not pressed by an external force is firstly obtained. Notably, because the first flexible substrate 11 and the second flexible substrate 21 are both formed of a flexible material, they may possibly be slightly bent when placed flat and still, so that a gap naturally formed may exist between the first conductive pattern 12 and the second conductive pattern 22; as a result, the first conductive pattern 12 and the second conductive pattern 22 may not completely and fittingly contact to conduct the electric signal, and any electrical conduction signal at current stage shall be considered as noise. Therefore, the setting of the threshold value is needed for eliminating the interference issue of noise. After that, when a pressure is imposed by a certain application purpose, the gap is pressed to disappear, so that the first conductive pattern 12 and the second conductive pattern 22 are completely adhered, and the pressurized signal generated when the first pressure sensing sheet 10 and the second pressure sensing sheet 20 are pressed by an external force is accordingly obtained. The processing device 30 processes the initial signal generated without pressurization of external force and the pressurized signal generated with pressurization to generate an exclusive threshold value, which is set as the preferred determination basis. Then, exclusive threshold value is used for subsequent application purpose for generating an accurate measurement result. Notably, if this system is used on a mattress, in response to the conditions of users of different body types through the setting of exclusive threshold value, a lower threshold value accordingly obtained can increase the sensitivity and prevent missed detection for a relatively smaller size user. As for the case of a larger size user, a higher threshold accordingly obtained can prevent the issue of noise interference affecting the actual measurement accuracy. The magnitude of the pressurized signal can be used to determine the magnitude of the pressure imposed by the external force.

For example, when the pressure sensing system 100 of the present invention is used to monitor a patient keeps lying in the same posture for a long time, the first pressure sensing sheet 10 and the second pressure sensing sheet 20 can be placed on a mattress, so as to obtain the initial signal first before the patient lies on the mattress. When the patient lies on the mattress, the pressurized signal is obtained. Afterward, the processing device 30 processes the exclusive threshold value for the patient.

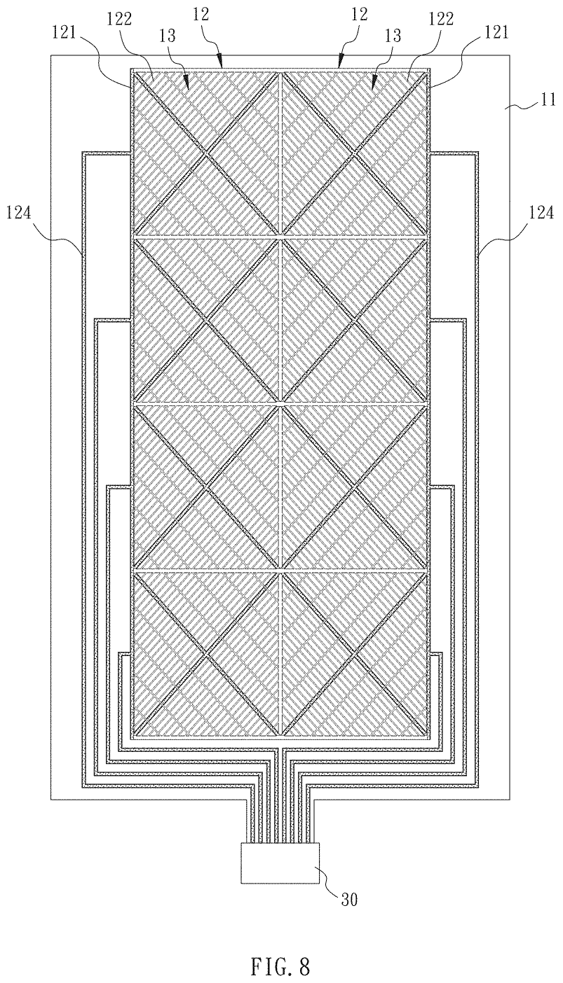

Referring to FIG. 8, the second embodiment of the present invention is illustrated, wherein the difference compared with the aforementioned embodiment lies in that the pressure sensing system 100 further comprises following features.

The first pressure sensing sheet 10 comprises a plurality of first conductive patterns 12. Each first conductive pattern 12 comprises a first transmission portion 124. Each first transmission portion 124 is independently electrically connected with the processing device 30. Two ends of each first transmission portion 124 are connected with the processing device 30 and each first conductive pattern 12, respectively. In the embodiment, the first conductive patterns 12 are arranged at intervals in a longitudinal or transverse direction of the first pressure sensing sheet 10.

The second pressure sensing sheet 20 comprises a plurality of second conductive patterns 22. Each second conductive pattern 22 comprises a second transmission portion 224. Each second transmission portion 224 is independently electrically connected with the processing device 30. Two ends of each second transmission portion 224 are connected with the processing device 30 and each second conductive pattern 22, respectively. In the embodiment, the second conductive patterns 22 are arranged at intervals in a longitudinal or transverse direction of the second pressure sensing sheet 20. In the embodiment, the second pressure sensing sheet 20 is structurally identical to the first pressure sensing sheet 10. Therefore, only reference numbers relative to the first pressure sensing sheet 10 are shown in FIG. 8.

Therefore, amounts of the first conductive patterns 12 and the second conductive patterns 22 of the first pressure sensing sheet 10 and the second pressure sensing sheet 20 are allowed to be increased according to the requirement of the square measure of the measurement; also, when each first conductive pattern 12 and the second conductive pattern 22 is pressed, each second transmission portion 224 sends the pressure sensing signal back to the processing device 30, so as to identify different pressed portions and square measure, thereby achieving pressure detection in different ranges.

For example, when the pressure sensing system 100 of the present invention is used to monitor a patient keeps lying in the same posture for a long time, the first pressure sensing sheet 10 and the second pressure sensing sheet 20 can be placed on a mattress. When the patient lies on the mattress, according to the pressure sensing signals sent back by each second transmission portions 224, it can be known that the pressure sensing signals sent back by the first conductive patterns 12 and the second conductive patterns 22 arranged close to the upper body is larger than the pressure sensing signals sent back by the first conductive patterns 12 and the second conductive patterns 22 of other parts; therefore, it can be known that the weight of the patient is mainly concentrated on the upper body, so as to identify different pressured portions and square measures.

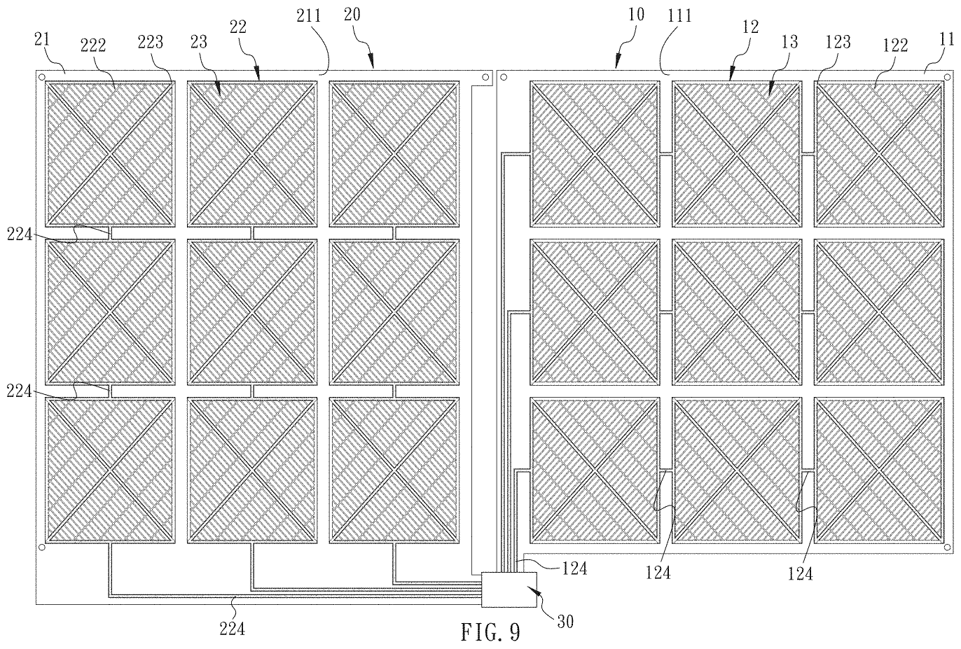

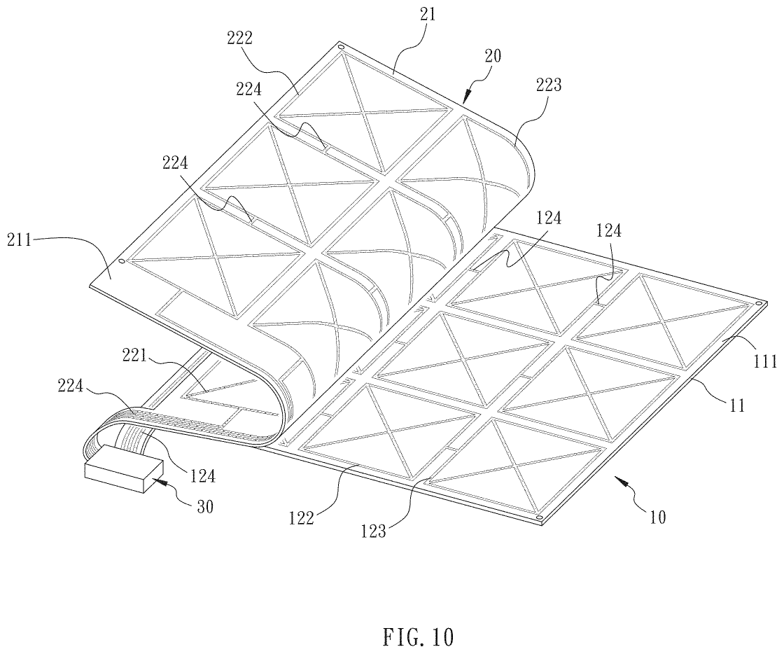

Referring to FIG. 9 to FIG. 11, the third embodiment of the present invention is illustrated, wherein the difference compared with the aforementioned embodiment lies in following features.

The first pressure sensing sheet 10 comprises a plurality of first conductive patterns 12. The first conductive patterns 12 are arranged in a two-dimensional array. The first transmission portions 124 of each first conductive pattern 12 are connected along a first direction. In the embodiment of the present invention, based on the direction shown on FIG. 9 from top to bottom, the first conductive patterns 12 are connected into a first row, a second row, and a third row. The processing device 30 orderly sends out a signal to the first conductive pattern 12 to each row, and the first conductive patterns 12 of each row are electrically conducted because of the electrical connection of the first transmission portion 124.

The second pressure sensing sheet 20 comprises a plurality of second conductive patterns 22. The second conductive patterns 22 are arranged in a two-dimensional array. The second transmission portions 224 of each second conductive pattern 22 are connected along a second direction. The first direction and the second direction are cross setting. In the embodiment of the present invention, based on the direction shown on FIG. 9 from left to right, the second conductive patterns 22 are connected into a first column, a second column, and a third column. In the embodiment, the second conductive patterns 22 of each column are electrically connected with the processing device 30 through the second transmission portion 224, so as to send the electric signal back to the processing device 30.

The first pressure sensing sheet 10 and the second pressure sensing sheet 20 are stacked up. When the first pressure sensing sheet 10 and the second pressure sensing sheet 20 are pressed to contact each other, the pressed first conductive pattern 12 and the second conductive pattern 22 are electrically conducted, such that the signal sent by the processing device 30 flows through the first conductive pattern 12 and the second conductive pattern 22 and back to the processing device 30, facilitating the pressed positions will be identified.

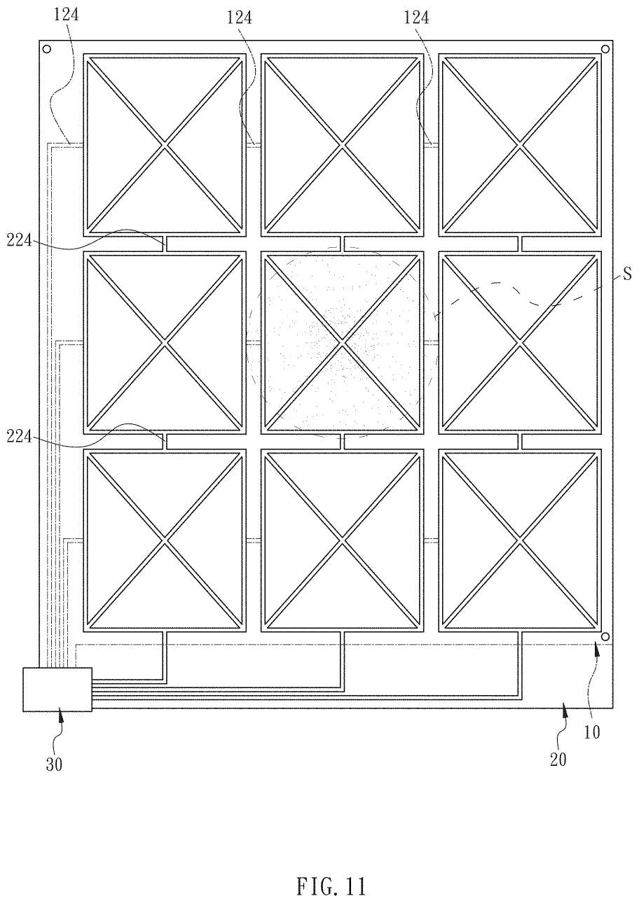

For example, referring to FIG. 9 and FIG. 11, when the first pressure sensing sheet 10 and the second pressure sensing sheet 20 are pressed by an external force S, the first conductive pattern 12 in the middle of the second row and the second conductive pattern 22 in the middle of the second column that are pressed by the external force S are electrically connected. The processing device 30 receives the pressurized signal from the second conductive pattern 22 only when the electric power passes through the first conductive pattern 12 which is pressed by the external force S; regarding other first conductive patterns 12 and second conductive patterns 22 that are not pressed by the external force S, only initial signals are received. Therefore, the pressed position is acquired according to the reacting first conductive pattern 12 and second conductive pattern 22. Also, the square measure pressed by the external force is the square measure of the stacked portion of the single first conductive pattern 12 and second conductive pattern 22 that are pressed, and so on. When multiple conductive patterns are simultaneously pressed by an external force, the processing device 30 can also identify that multiple positions are pressed according to the sources of the simultaneously received feedbacks and the signal strengths thereof.

With the foregoing configuration, the present invention achieves following effects.

The pressure sensing system 100 of the present invention applies a simple structure with the threshold value setting and judgment of the processing device 30 to effectively prevent the generation of measurement erroneous signals, so as to improves the disadvantages of conventional art requiring a complex structure to avoid measurement errors, thereby effectively reducing the manufacturing process and cost of the first pressure sensing sheet 10 and the second pressure sensing sheet 20 of the present invention.

The present invention transmits the electric signal to the first low conductivity circuit 122 through the first high conductivity circuit 121. When the first pressure sensing area 13 of the first low conductivity circuit 122 and the second pressure sensing area 23 of the second low conductivity circuit 222 contact, the pressure sensing signal is generated, which is sent back through the second high conductivity circuit 221 to the processing device 30 for subsequent process and identification, thereby improving the sensitivity and accuracy of the measurement through the design of the high and low conductivity circuits.

With the configuration of first insulation layer 123 and the second insulation layer 223, the present invention prevents the issue of excessive current consumption due to the contact of the first high conductivity circuit 121 and the second high conductivity circuit 221. On the one hand, serious power loss is avoided; on the other hand, the pressure sensing signal directly transmitted through the first high conductivity circuit 121 and the second high conductivity circuit 221 and causing an inaccurate measurement can be prevented.

The first conductive pattern 12 and the second conductive pattern 22 of the present invention are formed on the first pressure sensing sheet 10 and the second pressure sensing sheet 20 in a printed circuit manner, such that the first pressure sensing sheet 10 and the second pressure sensing sheet 20 are formed in a flatly thin sheet. When the first pressure sensing sheet 10 and the second pressure sensing sheet 20 are applied for wearable pressure detection or medical pressure detection, the user is prevented from having a sensation of foreign body, so that the comfort of application is provided.

The present invention processes the initial signal generated without pressurization and the pressurized signal generated under pressurization to generate the threshold value as the preferred determination basis. Thus, exclusive threshold values for different application purposes, thereby improving the measurement accuracy.

Regarding the present invention, the amounts of the conductive patterns on the pressure sensing sheets can be increased according to the requirement of the square measure of measurements. Also, when each conductive pattern is pressed, the transmission portion sends the pressure sensing signal back to the processing device 30, respectively, so as to identify the pressed portion and square measure, thereby achieving pressure detection in different ranges.

The above-mentioned embodiments are only used for illustrating the present invention, instead of limiting the scope of the present invention. All modifications or changes made departing from the spirit of the present invention fall within the scope of protection intentions of the present invention.

1. A pressure sensing system, comprising:
a first pressure sensing sheet comprising a first flexible substrate and a first conductive pattern, the first conductive pattern being disposed on a surface of the first flexible substrate;
a second pressure sensing sheet comprising a second flexible substrate and a second conductive pattern, the second conductive pattern being disposed on a surface of the second flexible substrate, wherein the second pressure sensing sheet has one side of the second conductive pattern stacked with one side of the first conductive pattern of the first pressure sensing sheet; and
a processing device electrically connected with the first pressure sensing sheet and the second pressure sensing sheet, the processing device outputting an electric signal to the first pressure sensing sheet, the second pressure sensing sheet obtaining a pressure sensing signal; the pressure sensing signal being compared with a threshold value, so as to determine if the first pressure sensing sheet and the second pressure sensing sheet are pressed by an external force.

2. The pressure sensing system of claim 1, wherein the first conductive pattern comprises a first high conductivity circuit and a first low conductivity circuit electrically connected with the first high conductivity circuit; the first low conductivity circuit extends from the first high conductivity circuit to form a first pressure sensing area on the first flexible substrate; the first pressure sensing area has a square measure larger than a square measure occupied by the first high conductivity circuit on the first flexible substrate; the second conductive pattern comprises a second high conductivity circuit and a second low conductivity circuit electrically connected with the second high conductivity circuit; the second low conductivity circuit extends from the second high conductivity circuit to form a second pressure sensing area on the second flexible substrate; the second pressure sensing area has a square measure larger than a square measure occupied by the second high conductivity circuit on the second flexible substrate.

3. The pressure sensing system of claim 2, wherein the first low conductivity circuit is divided into a first cover area and a first distribution area; the first cover area is disposed on one side of the first high conductivity circuit away from the first flexible substrate, and the first distribution area is disposed on the first flexible substrate; the second low conductivity circuit is divided into a second cover area and a second distribution area; the second cover area is disposed on one side of the second high conductivity circuit away from the second flexible substrate, and the second distribution area is disposed on the second flexible substrate.

4. The pressure sensing system of claim 3, wherein the first pressure sensing sheet further comprises a first insulation layer, and the first insulation layer covers one side of the first high conductivity circuit away from the first flexible substrate; the second pressure sensing sheet further comprises a second insulation layer, and the second insulation layer covers one side of the second high conductivity circuit away from the second flexible substrate.

5. The pressure sensing system of claim 4, wherein the first insulation layer covers the first cover area; the second insulation layer covers the second cover area.

6. The pressure sensing system of claim 1, wherein a plurality of first conductive patterns are provided; each first conductive pattern comprises a first transmission portion; each first transmission portion is independently electrically connected with the processing device; two ends of each first transmission portion are connected with the processing device and each first conductive pattern, respectively; a plurality of second conductive patterns are provided; each second conductive pattern comprises a second transmission portion; each second transmission portion is independently electrically connected with the processing device; two ends of each second transmission portion are connected with the processing device and each second conductive pattern, respectively.

7. The pressure sensing system of claim 1, wherein a plurality of first conductive patterns are provided; each first conductive pattern comprises a first transmission portion; the first conductive patterns are arranged in a two-dimensional array; the first transmission portions of each first conductive pattern are connected along a first direction; a plurality of second conductive patterns are provided; each second conductive pattern comprises a second transmission portion; the second conductive patterns are arranged in a two-dimensional array; the second transmission portions of each second conductive pattern are connected along a second direction; the first direction and the second direction are cross setting.

8. The pressure sensing system of claim 1, wherein the pressure sensing signal is a current value; when the pressure sensing signal is larger than the threshold value, the processing device determines that the first pressure sensing sheet and the second pressure sensing sheet are pressed by an external force.

9. A pressure sensing setting method executed with the pressure sensing system of claim 1, the pressure sensing setting method comprising following steps:
the processing device receiving an initial signal which is generated by the second pressure sensing sheet when the first pressure sensing sheet and the second pressure sensing sheet are not pressed by an external force;
the processing device receiving a pressurized signal generated by the second pressure sensing sheet when the first pressure sensing sheet and the second pressure sensing sheet are pressed by an external force; and
the processing device processing the initial signal and the pressurized signal to generate the threshold value.

10. The pressure sensing setting method of claim 9, wherein the processing device divides a sum of the initial signal and the pressurized signal by a reference value to obtain the threshold value.
